(19) United States
(12) Patent Application Publication
(10) Pub. No.: US 2023/0299618 A1
(43) Pub. Date: Sep. 21, 2023

(54) WIRELESS COMMUNICATION DEVICE AND METHOD OF USING

(71) Applicant: Wireless Electrical Grid LAN, WiGL Inc., Hampton, VA (US)

(72) Inventors: Ahmad L.D. Glover, Hampton, VA (US); Alfred Lewis Anderson, Houston, TX (US)

(73) Assignee: Wireless Electrical Grid LAN, WiGL Inc., Hampton, VA (US)

(21) Appl. No.: 18/129,020

(22) Filed: Mar. 30, 2023

Related U.S. Application Data
(63) Continuation-in-part of application No. 18/120,782, filed on Mar. 13, 2023.
Application No. 18/120,782 is a continuation of application No. 17/033,824, filed on Sep. 27, 2020, now Pat. No. 11,605,983.
Application No. 17/033,824 is a continuation-in-part of application No. 17/019,312, filed on Sep. 13, 2020, now Pat. No. 11,557,927.
Application No. 17/019,312 is a continuation-in-part of application No. 16/482,347, filed on Jul. 31, 2019, now Pat. No. 10,992,158.
Application No. 16/482,347 is a continuation-in-part of application No. 15/640,574, filed on Jul. 2, 2017, now Pat. No. 9,985,465.
(60) Provisional application No. 62/506,737, filed on May 16, 2017.

(51) Int. Cl. H02J 50/20; H02J 7/00; H02J 7/02

(52) U.S. Cl. CPC H02J 50/20; H02J 7/00032; H02J 7/0048; H02J 7/02

(57) ABSTRACT

A renewable energy portable electric vehicle charging system having an inlet coupled to a portable electrical power generating source, and an outlet couplable to an electrical input of a storage battery system in which the portable electrical power generating source is a self-charging battery activated by an aqueous electrolyte. A method of utilizing the system is also disclosed.

### CROSS-REFERENCES TO RELATED APPLICATIONS

This application is a continuation-in-part of co-pending U.S. Pat. Application No. 18/120782, filed Mar. 13, 2023, which is continuation of U.S. Pat. Application No.17/033,824 filed Sep. 27, 2020, now U.S. 11,605,983 issued Mar. 14, 2023, and a continuation-in-part of International Patent Application No. PCT/US22/21787, filed Mar. 24, 2022, which claims priority to U.S. Pat. Application No. 17/163,001, filed Jan. 29, 2021, now US 11,557,926 issued Jan. 17, 2023, which is a continuation-in-part of US 17/033,824, filed Sep. 27, 2020, which is a continuation in part of U.S. Pat. Application No. 17/019,312 filed Sep. 13, 2020, now US 11,557,927 issued Jan. 17, 2023, which is continuation in part of U.S. Pat. Application No. 16/482,347 filed Jan. 28, 2018, now U.S. 10,992,158 issued Apr. 27, 2021, which is a continuation-in-part of U.S. Pat. Application No. 15/640,574 filed Jul. 2, 2017, now US 9,985,465 issued May 29, 2018, which claims priority to U.S. Provisional Pat. Application No. 62/506,737 filed May 16, 2017. The entire disclosures of which are incorporated by reference herein.

### BACKGROUND

Electrical power is necessary for electric devices to function. Providing electrical power to devices not connected with a land-based power grid, or to mobile devices, or moving electrically powered vehicles requires a physical electrical connection between a stationary power source and the electric device.

Electric vehicles in operation and remote electrical devices are not readily connectable to a wired power grid. Providing electrical power to recharge electric storage batteries which power electrically powered vehicles typically requires taking the vehicle out of operation. However, in some instances this is not possible, e.g., during powered flight in an emergency situation.

Providing electrical power to recharge electric storage batteries which power electrically powered devices in remote environments, which for purposes herein refers to environments devoid of electrical connections to a power grid, typically requires providing power generation equipment, typically powered by a combustible fuel source, or charging a power source via a grid connection e.g., charging a storage battery, and then carting the battery to the remote location to either recharge or replace the depleted electric storage batteries as the remote location. However, in various situations this is not readily possible or economical due to external factors such as armed conflicts or natural disasters despite the fact that human lives may depend on having the electrical power.

In other situations, such storage batteries may be recharged using solar power. However, such power is only available while the sun is shining, limiting the ability to generate power. Furthermore, solar power is not suitable for situations where emergency power may be required.

There is need for a system capable of providing electrical power to recharge electric storage batteries which power electrically powered devices such as electric vehicles during operation, in remote environments, and/or which are suitable to provide emergency power on demand. This need extends to situations which do not require a combustible fuel source or charging a power source via a grid connection drawing power from a land-based electric grid.

### SUMMARY

Embodiments of this disclosure are directed to a power system capable of providing electrical power to recharge electric storage batteries which power electrically powered devices such as electric vehicles during operation, in remote environments, and/or which are suitable to provide emergency power on demand, which does not require a combustible fuel source or charging a power source via a grid connection drawing power from a land-based electric grid.

In embodiments, a power system comprises a power charging system having an inlet coupled to a renewable energy portable electrical power generating source, and an outlet couplable to an electrical input of a storage battery system; the power charging system configured to provide electrical power from the portable electrical power generating source to a storage battery of the storage battery system in an amount sufficient to at least partially recharge the storage battery; the portable electrical power generating source comprising a cell enclosure comprising an anode having a standard reduction potential of less than or equal to about -1 V separated from a cathode having a standard reduction potential of greater than or equal to about 0.1 V disposed within, wherein the anode and the cathode are each in electrical communication with the power charger system; wherein the container further comprises an electrolyte inlet through which an aqueous electrolyte may be introduced in contact with the anode and the cathode, thereby causing generation of electrical power.

In embodiments, a method of providing electrical power to an electrical device not receiving power from a land-based power grid, comprises:
a) introducing an aqueous electrolyte into an electrolyte inlet of a cell enclosure of a renewable energy portable electrical power generating source, thereby causing generation of electrical power, the cell enclosure comprising an anode having a standard reduction potential of less than or equal to about -1V separated from a cathode having a standard reduction potential of greater than or equal to about 0.1 V disposed within, and wherein the anode and the cathode are each in electrical communication with a power charger system having an power inlet coupled to the portable electrical power generating source, and a power outlet couplable to an electrical input of a storage battery system; the power charging system configured to provide electrical power from the portable electrical power generating source to a storage battery of the storage battery system in an amount sufficient to at least partially recharge the storage battery; and
b) directing the electrical power from the power charger system into the storage battery system to charge a storage battery of the storage battery system, and/or to power an electric device powered by the storage battery system.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system according to embodiments of this disclosure;

FIG. 2 is a block diagram of an exemplary embodiment of a self-charging battery according to embodiments disclosed herein.

FIG. 3 is a schematic diagram of an embodiment of a salt water generator according to embodiments disclosed herein.

FIG. 4A is a perspective view of a portable electrical power generating source according to embodiments disclosed herein.

FIG. 4B is a perspective view of a portable electrical power generating source according to embodiments disclosed herein.

FIG. 5 is a perspective cut-away and exploded view of a portable electrical power generating source having a removable electrode according to embodiments disclosed herein.

### DETAILED DESCRIPTION

In embodiments, a power system comprising a power charging system having an inlet coupled to a portable electrical power generating source, and an outlet couplable to an electrical input of a storage battery system. In embodiments, the power charging is configured to convert the power provided by the electrical power generating source to a form, e.g., a voltage, current, type, and the like, which is suitable for recharging the intended storage battery system, which may include controlling the voltage and current provided as required by the particular storage battery system being recharged. In some embodiments, the outlet of the power charging system may be coupled to the electrical input of the storage battery system by a direct wired connection, or may be coupled to the electrical input of the storage battery system by a wireless connection, e.g., a directed energy beam system as disclosed in the applicant’s co-authored U.S. 11,557,926, the contents of which are fully incorporated herein by reference.

As referred to herein, a portable electrical power generating source refers to a power source which is not connected to, nor which has previously drawn the electrical power from a wired connection to a power grid. Accordingly, for purposes herein the portable electrical power generating source is not a battery which was first charged by an electrical connection to an electric power grid. In embodiments, the portable electrical power generating source is self -generating, meaning that the portable electrical power generating source does not require consumption of a flammable fuel in an internal combustion engine or gas turbine to rotate a mechanical electric generator to produce the electric power.

In embodiments, the power charging system is configured to provide electrical power from the portable electrical power generating source to a storage battery of the storage battery system in an amount sufficient to at least partially recharge the storage battery.

In embodiments, the portable electrical power generating source comprises a cell enclosure comprising an anode having a standard reduction potential of less than or equal to about -1 V separated from a cathode having a standard reduction potential of greater than or equal to about 0.1 V disposed within, wherein the anode and the cathode are each in electrical communication with the power charger system. In some embodiments, the cell enclosure also serves as the anode or the cathode. For example, the cathode may be formed in a shape of the enclosure such that an outer surface of the cathode forms an outer surface of the portable electrical power generating source.

In embodiments, the enclosure further comprises an electrolyte inlet through which an aqueous electrolyte may be introduced in contact with the anode and the cathode, thereby causing generation of electrical power, i.e., self generating without having to first charge the power source with electric power.

In embodiments, the anode comprises a metal from Group 1 or 2 of the periodic table of the elements. In embodiments, the anode comprises magnesium. In embodiments, the anode is magnesium metal, or a magnesium alloy comprising at least 50 wt% magnesium. In embodiments, the anode consists essentially of magnesium metal, which in embodiments may have purity of greater than or equal to about 95 wt% magnesium.

In embodiments, the cathode comprises a metal from Group 5 through Group 12 of the periodic table of the elements. In embodiments, the cathode comprises iron, copper and/or nickel metal. In embodiments, the cathode comprises copper metal. In embodiments, the cathode consists essentially of copper metal, which in embodiments may have purity of greater than or equal to about 95 wt% copper.

In embodiments, the portable electrical power generating source further comprises an electrolyte reservoir which is configured to be placed into fluid communication with the electrolyte inlet through a valve, such that an aqueous electrolyte present in the electrolyte reservoir may be introduced into the cell enclosure by placing the valve in an open position. In embodiments, this valve may be a gate valve, or may be a barrier or weir type valve which requires manipulation of the electrolyte reservoir to cause the aqueous electrolyte to flow into the cell enclosure via gravity. For example, via tipping or rotating of the electrolyte reservoir a path is created which allows the aqueous electrolyte to flow into the cell enclosure via gravity.

In embodiments, the portable electrical power generating source may further comprise a water soluble salt disposed within the cell enclosure and/or along a fluid path into the cell enclosure, in an amount sufficient to mix with an aqueous electrolyte introduced into the electrolyte inlet thereby causing generation of the electrical power.

In some embodiments, the water soluble salt is directly disposed within the cell enclosure in an amount sufficient, such that upon directing water or another aqueous solution into the cell enclosure through the electrolyte inlet, the aqueous electrolyte suitable to cause generation of electrical power is formed. In other embodiments, this water soluble salt is disposed in the fluid path between the electrolyte inlet and the internal chamber of the cell. For example, a plug-flow tube wherein an aqueous solution comes in contact with the water soluble salt as it flows into the cell enclosure.

In embodiments, the water soluble salt is disposed within the cell enclosure and/or within a flowpath leading to the cell enclosure in the form of a solid. In other embodiments, the water soluble salt is at least partially dissolved in a solvent, e.g., a brine or a sol. In embodiments, the salt comprises, consists essentially of, or is sodium chloride. However, other salts may be used so long as generation of electrical power is caused by introducing the aqueous electrolyte in contact with the anode and the cathode.

In embodiments, a suitable pH for the electrolyte is from about 4 to about 8 at 25° C. In some embodiments, the pH for the electrolyte is from about 6 to about 7.5.

In embodiments, the cell enclosure further comprises an electrolyte outlet having an open and a closed position, wherein the open position allows the electrolyte to be removed e.g., drained, from the cell enclosure. In embodiments, this may include a valve, a removable, plug, and/or the like.

In embodiments, the anode, the cathode, or both are removably engaged with the cell enclosure so as to be replaceable.

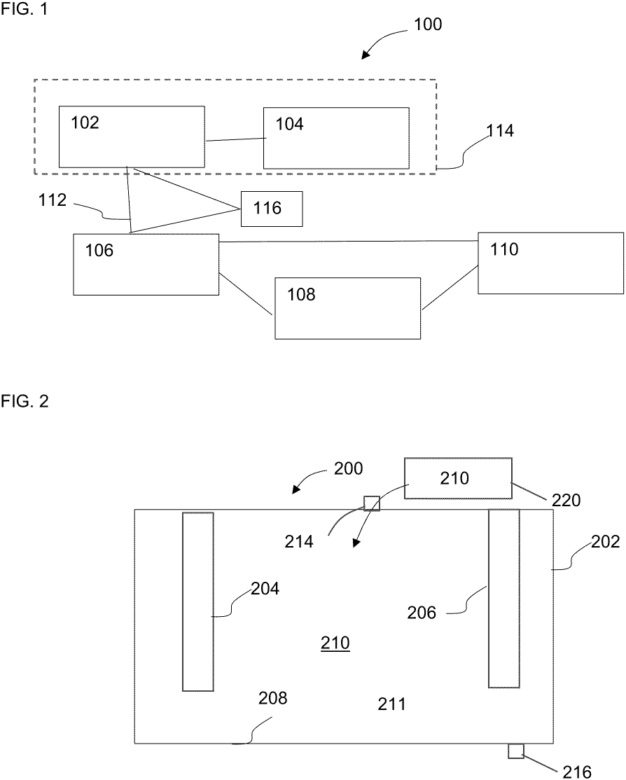

In embodiments, the portable electrical power generating source comprises a plurality of cell enclosures, each in electrical communication with at least one other. In embodiments, the power charging system is in wired electrical communication with the storage battery system. In embodiments, the power system is in wireless electrical communication with the storage battery system. FIG. 1 is a block diagram depicting a system 100 according to embodiments disclosed herein comprising a power charger system 102 coupled to a portable electrical power generating source 104, wherein the power charge system 102 is in electrical communication with the electrical power generating source 104. The power charge system 102 is also in electrical communication with a storage battery system 106, which is ultimately in electrical communication with a storage battery 108, and/or an electrically powered device 110. As shown in FIG. 1, in embodiments, the power charger system 102 may be in electrical communication with the storage battery system 106 through an intermediate power bank 116 comprising a rechargeable battery, one or more capacitors, or a combination thereof. The intermediate power bank 116 may be utilized to store electrical power prior to directing the electrical power to the electric device 110. In embodiments, the electrical communication between the power charger system 102 and the storage battery system 106 may be direct electrical communication, e.g., wired, or in other embodiments, the electrical communication between the power charger system 102 and the storage battery system 106 may be wireless electrical communication.

The power charger system 102 is configured to provide electrical power 112 to the storage battery system 106 and the storage battery system 106 configured to harvest and store at least a portion of the electrical power 112 and direct the electrical power to charge an electrical storage device 108 and/or provide electrical power directly to power the electric device 110.

The power charger system 102 is coupled to a renewable energy portable electrical power generating source 104, which supplies all of the power to the power charge system 102. In embodiments, the power charger system 102 may be physically attached to, and/or integral with the portable electrical power generating source, indicated by dotted rectangle 114.

FIG. 2 depicts a block diagram of a renewable energy portable electrical power generating source in the form of a self-charging battery 200 comprising a cell enclosure 202 comprising at least two electrodes, a cathode 204 separated from an anode 206 within cell enclosure 202. In embodiments, the cathode also forms the outer wall 208 of the cell enclosure 202. The electrodes 206 and 208 are connected to the power charger system. The power generation of the self-charging battery 200 occurs upon introduction of an aqueous electrolyte 210 i.e., a polar conductive fluid, being introduced into the enclosure, e.g., through the electrolyte inlet 214 of the cell enclosure 202. The cell enclosure may further include an electrolyte outlet 216 having an open and a closed position, wherein the open position allows the electrolyte to drain from the cell enclosure.

In embodiments, the aqueous electrolyte 210 comprises seawater. In some embodiments, the aqueous electrolyte 210 comprises an aqueous solution comprising a salt. Suitable salts include NaCl, KCl, KBr, and many others. In embodiments, the aqueous electrolyte 210 comprises, as saturated solution of sodium chloride, commonly referred to as brine. In embodiments, any conductive aqueous liquid may be utilized. In some embodiments, the aqueous electrolyte 210 comprises, or is human or mammalian urine, which is typically abundant in dire situations where emergency power may be needed.

In embodiments, the self-charging battery 200 comprises at least a portion of the salt 211 disposed in solid or semi-solid form within the cell enclosure 202. This allows for fresh water or any aqueous solution to be added to the self-charging battery 200 to form the aqueous solution comprising the salt, i.e., the electrolyte 210 and thereby generate power upon introduction of the water or an aqueous solution into the cell enclosure 202 of the self charging battery 202. 95 wt% copper.

In embodiments, the renewable energy portable electrical power generating source further comprises an electrolyte reservoir 220 which is configured to be placed into fluid communication with the electrolyte inlet 214 through a valve, such that an aqueous electrolyte 210 present in the electrolyte reservoir 220 may be introduced into the cell enclosure 202 by placing the valve in an open position, and/or manipulating the electrolyte reservoir 220 to allow the electrolyte 210 to flow into the cell enclosure 202 by gravity.

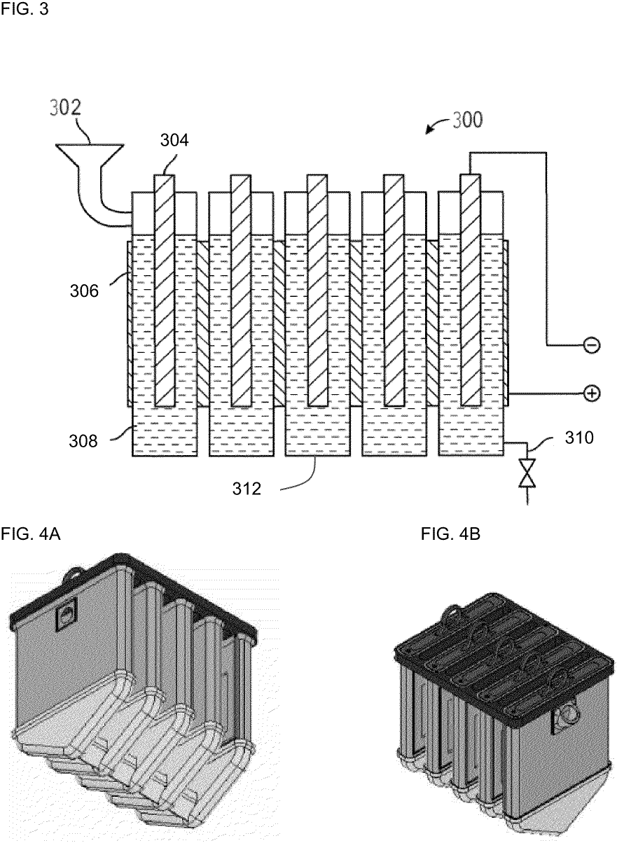

FIG. 3 is a schematic depiction of a renewable energy portable electrical power generating source in the form of a salt water generator 300. The salt water generator 300 has replaceable magnesium anode plates 304 spaced between cathodes 306 and is filled with a saltwater electrolyte 308. The salt water generator 300 also has an electrolyte fill port 302 for adding fresh electrolyte 308 and a drain 310 for removing spent electrolyte 308. The battery can be transported without the electrolyte 308, making it lighter, and the electrolyte can be added prior to use. Further, the electrolyte can be prepared by adding salt (NaCl) to fresh water, e.g., using a premeasured packet of salt to be added to a specified volume of fresh water, or if available, seawater may be used as the electrolyte. In other embodiments, the salt is present in the cell enclosure 312 and fresh water is added to the form the saltwater electrolyte 308.

In embodiments, at least one of the anode and the cathode comprises a metal from Group 1 or 2 of the periodic table of the elements, which is typically the anode 304. Suitable materials include lithium and magnesium. However, other metals and/or alloys are suitable.

In embodiments, one or more of the cathode and the anode are dimensioned and arranged to be removably engaged with the galvanic cell, and wherein one or more of the cathode and the anode may be replaced, along with replacement of spent electrolyte.

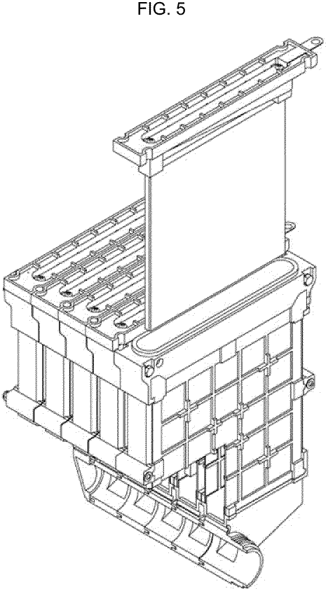

FIG. 4A is a perspective view of a portable electrical power generating source according to embodiments disclosed herein. FIG. 4B is a perspective view of the portable electrical power generating source shown in FIG. 4A. FIG. 5 is a perspective cut-away and exploded view of a portable electrical power generating source having a removable electrode according to embodiments disclosed herein.

In embodiments, the power charger system determines a status of the storage battery system. This status may include a physical property of the electric device, e.g., a level of charge of the device, information on the brand, capacity, and/or requirements of the device, and/or the like. In some embodiments, the power charge system according to one or more embodiments disclosed herein is configured to determine an authorization status of the storage battery system based on predetermined criteria according to a determination step.

If the determination of an authorization status of the electric device returns a negative or “not authorized” status, wherein the storage battery system is not authorized to receive charging from the power charge system, the method may include configuring the storage battery system to prevent receiving charging from the power charge system.

If the determination of an authorization status of the device returns a positive or “authorized” status, wherein the electric device is authorized to receive charging from the power charge system, storage battery system may be configured to receive charging from the power charge system according to one or more configuring criteria.

This authorization status comprising a determination by the power charger system whether or not the electric device is authorized to receive charging from the power charge system may be based on one or more predetermined authorization criteria. For example, in an embodiment wherein the charging of the storage battery system is provided on a fee-based arrangement, such as via subscription. When the power charger system determines that the storage battery system is authorized to receive charging from the power charge system, a “positive” authorization is obtained. When the power charger system determines that the storage battery system is not authorized or unauthorized to receive charging from the power charge system, a “negative” authorization is obtained.

In embodiments, the determining of the authorization status comprises determining if the storage battery system is, or is not associated with a user account authorized to receive charging from the power charge system, based on one or more predetermined authorization criteria.

In some embodiments, the authorization criteria include an authorization key, a lookup table, an identifier unique to the electric device, an indication of the electric device comprising an active service subscription, an indication of the storage battery system and/or an attached electric device comprising an active prepaid subscription, or a combination thereof. In other embodiments, the storage battery system may include an RFID tag or other means of identification.

In embodiments, the power system is dimensioned and arranged to be physically attached to, and electrically coupled to an electric powered vehicle. In embodiments, the power system is integral to an electric powered vehicle.

In embodiments, a method of providing electrical power to an electrical device not receiving power from a land-based power grid, comprising: introducing an aqueous electrolyte into an electrolyte inlet of a cell enclosure of a renewable energy portable electrical power generating source, thereby causing generation of electrical power, the cell enclosure comprising an anode having a standard reduction potential of less than or equal to about -1V separated from a cathode having a standard reduction potential of greater than or equal to about 0.1 V disposed within, and wherein the anode and the cathode are each in electrical communication with a power charger system having an power inlet coupled to the renewable energy portable electrical power generating source, and a power outlet couplable to an electrical input of a storage battery system. The power charging system is configured to provide electrical power from the renewable energy portable electrical power generating source to a storage battery of the storage battery system in an amount sufficient to at least partially recharge the storage battery.

The method then includes directing the electrical power from the power charger system into the storage battery system to charge a storage battery of the storage battery system, and/or to power an electric device powered by the storage battery system.

In embodiments, the aqueous electrolyte comprises seawater, an aqueous solution comprising a salt, brine, urine, or a combination thereof.

In embodiments, the storage battery system is located within, and powers an electrically powered vehicle. In embodiments, the renewable energy portable electrical power generating source is located within, or attached to the electrically powered vehicle. In embodiments, the power is being provided to the electrically powered vehicle while the electrically powered vehicle is in operation, e.g., while moving. In other embodiments, the electric device is a solar power storage battery and/or a storage battery which powers a remote electrical device.

In embodiments, the power charger system and the renewable energy portable electrical power generating source, and the power receiver are located within or on e.g., integral to, an electrically powered vehicle. In embodiments, the system according to embodiments disclosed herein is suitable to provide emergency or backup electrical power to electric vehicles e.g., an electric gas can. In embodiments, the wireless power receiver is located in a moving electrically powered vehicle. In some embodiments, the power charger system and the renewable energy portable electrical power generating source are stationary. In other embodiments, the power charger system and the portable electrical power generating source are located in a first moving vehicle, and the power receiver is located in a second moving vehicle, such that the second moving vehicle may be recharged and/or powered by the first moving vehicle via wireless electrical connection.

Electrically powered vehicles include terrestrial vehicles suitable for ground transportation, e.g. cars and truck, but may also include aerial vehicles e.g., fix or rotary wing aircraft, lighter than air vehicles, e.g., Chinse spy balloons, and the like.

In embodiments, the system is dimensioned and arranged to recharge solar powered batteries during periods in which the solar cells are not generating power. In embodiments, a plurality of systems may be utilized either in series to increase voltage, or in parallel to increase amperage of the system, depending on the electric device being charged. In embodiments, the system may be used to provide emergency power, or to provide power to systems in remote areas or during natural or manmade disasters.

### EXAMPLES

A salt water generator was prepared according to embodiments disclosed herein. The DC output of the salt water generator was loaded by a 12-ohm resistor for 10-hours. The discharge curve (voltage, and current) was recorded with respect to time. From this curve, the generator’s capacity was determined according to the following equation:

$$\text{E} \text{=} \text{V} \times \text{I} \text{×} \text{T}$$

wherein E = Generator Capacity [Wh];
V = Nominal Generator Voltage [V];
I = Discharge Current [A]; and
T = Time to discharge the generator to 50% [h]

The nominal generator voltage was measured to be 15.2 V.

The generator was discharged at approximately 1 Amp to a voltage of 10.7 V over a period of 9 hours and 51 min. The generator capacity was calculated to be 152 Wh to a fully charged state of 6 V with new plates and freshly prepared salt water.

The nominal generator voltage was measured to be 15.2 V. The generator was discharged at approximately 1 Amp to a voltage of 10.7 V over a period of 9 hours and 51 min. The generator capacity was calculated to be 152 Wh to a fully charged state of 6 V with new plates and freshly prepared salt water.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A power system comprising:
a power charging system having an inlet coupled to a renewable energy portable electrical power generating source, and an outlet couplable to an electrical input of a storage battery system;
the power charging system configured to provide electrical power from the portable electrical power generating source to a storage battery of the storage battery system in an amount sufficient to at least partially recharge the storage battery;
the portable electrical power generating source comprising a cell enclosure comprising an anode having a standard reduction potential of less than or equal to about -1 V separated from a cathode having a standard reduction potential of greater than or equal to about 0.1 V disposed within, wherein the anode and the cathode are each in electrical communication with the power charger system;
wherein the enclosure further comprises an electrolyte inlet through which an aqueous electrolyte may be introduced in contact with the anode and the cathode, thereby causing generation of electrical power.

2. The power system of claim 1, wherein the anode comprises a metal from Group 1 or 2 of the periodic table of the elements.

3. The power system of claim 1, wherein the anode comprises magnesium metal.

4. The power system of claim 1, wherein the cathode comprises copper metal.

5. The power system of claim 1, further comprising an electrolyte reservoir in fluid communication with the electrolyte inlet through a valve, such that an aqueous electrolyte present in the electrolyte reservoir may be introduced into the cell enclosure by placing the valve in an open position.

6. The power system of claim 1, further comprising a water soluble salt disposed within the cell enclosure in an amount sufficient to mix with an aqueous electrolyte introduced into the electrolyte inlet thereby causing generation of the electrical power.

7. The power system of claim 1, dimensioned and arranged to be physically attached to, and electrically coupled to an electric powered vehicle.

8. The power system of claim 1, wherein the anode, the cathode, or both are removably engaged with the cell enclosure so as to be replaceable.

9. The power system of claim 1, wherein the cell enclosure further comprises an electrolyte outlet having an open and a closed position, wherein the open position allows the electrolyte to drain from the cell enclosure.

10. The power system of claim 1, wherein a suitable pH for the electrolyte is from about 4 to about 8 at 25° C.

11. The power system of claim 1, comprising a plurality of cell enclosures, each in electrical communication with at least one other.

12. The power system of claim 1, wherein the power charging system is in wired electrical communication with the storage battery system.

13. The power system of claim 1, wherein the power charging system is in wireless electrical communication with the storage battery system.

14. The power system of claim 1, wherein the power charging system is in wired electrical communication with the storage battery system through an intermediate power bank comprising a rechargeable battery, one or more capacitors, or a combination thereof.

15. A method of providing electrical power to an electrical device not receiving power from a land-based power grid, comprising:
a) introducing an aqueous electrolyte into an electrolyte inlet of a cell enclosure of a renewable energy portable electrical power generating source, thereby causing generation of electrical power, the cell enclosure comprising an anode having a standard reduction potential of less than or equal to about -1V separated from a cathode having a standard reduction potential of greater than or equal to about 0.1 V disposed within, and wherein the anode and the cathode are each in electrical communication with a power charger system having an power inlet coupled to the portable electrical power generating source, and a power outlet couplable to an electrical input of a storage battery system; the power charging system configured to provide electrical power from the portable electrical power generating source to a storage battery of the storage battery system in an amount sufficient to at least partially recharge the storage battery;
b) directing the electrical power from the power charger system into the storage battery system to charge a storage battery of the storage battery system, and/or to power an electric device powered by the storage battery system.

16. The method of claim 15, wherein the aqueous electrolyte comprises seawater, an aqueous solution comprising a salt, brine, urine, or a combination thereof.

17. The method of claim 15, wherein the electric device is an electrically powered vehicle.

18. The method of claim 17, wherein the portable electrical power generating source is located within, or attached to the electrically powered vehicle.

19. The method of claim 18, wherein the power is being provided to the electrically powered vehicle while the electrically powered vehicle is in operation.

20. The method of claim 15, wherein the electric device is a solar power storage battery.
